(19) United States
(12) Patent Application Publication
(10) Pub. No.: US 2013/0319121 A1
(43) Pub. Date: Dec. 5, 2013

(54) Distributed Acoustic Sensing

(71) Applicants: David John Hill, Dorchester (GB); Christopher John Kelly, Worcester (GB)

(72) Inventors: David John Hill, Dorchester (GB); Christopher John Kelly, Worcester (GB)

(73) Assignee: OPTASENSE HOLDINGS LIMITED, Hampshire (GB)

(21) Appl. No.: 13/984,426

(22) PCT Filed: Feb. 27, 2012
(86) PCT No.: PCT/GB2012/000195

§ 371 Date: Aug. 8, 2013

(30) Foreign Application Priority Data
Feb. 25, 2011 (GB) 1103254.7

(51) Int. Cl. G01H 9/00

(52) U.S. Cl. CPC G01H 9/004
USPC 73/645; 385/13

(57) ABSTRACT

This application describes methods and apparatus for distributed acoustic sensing providing enhanced sensitivity for certain acoustic signals. The method uses a fibre optic distributed acoustic sensing (DAS) apparatus (106) to detect acoustic signals wherein the fibre optic distributed acoustic sensor comprises at least one optical fibre (104) deployed in an area of interest (204) such that at least one section of said optical fibre is deployed to monitor the acoustic response of a cavity (206) to incident acoustic signals. The cavity is dimensioned such that the cavity resonates at a desired frequency and thus the relevant sensing portions of the DAS sensor show an enhanced response to acoustic signals which excite resonance in the cavity. The optical fibre (104) may be deployed to run through said cavity.

The present invention relates to fibre optic distributed acoustic sensors and in particular to methods and apparatus for enhancing and/or tailoring the response for distributed acoustic sensors.

Various sensors utilizing optical fibres are known. Many such sensors rely on fibre optic point sensors or discrete reflection sites such as fibre Bragg gratings or the like being arranged along the length of an optical fibre. The returns from the discrete point sensors or reflection sites can be analysed to provide an indication of the temperature, strain and/or vibration in the vicinity of the discrete sensors or reflection sites.

Such sensors using discrete reflection sites or fibre optic point sensors require the optical fibre including the sensor portions to be specially fabricated. Further the distribution of the sensors within the optical fibre is fixed.

Fully distributed fibre optic sensors are also known in which the intrinsic scattering from a continuous length of optical fibre is used. Such sensors allow use of standard fibre optic cable without deliberately introduced reflection sites such fibre Bragg gratings or the like. The entire optical fibre from which a backscatter signal can be detected can be used as part of the sensor. Time division techniques are typically used to divide the signal returns into a number of time bins, with the returns in each time bin corresponding to a different portion of the optical fibre. Such fibre optic sensors are referred to as distributed fibre optic sensors as the sensor options are fully distributed throughout the entire optical fibre. As used in this specification the term distributed fibre optic sensor will be taken to mean a sensor in which the optical fibre itself constitutes the sensor and which does not rely on the presence of specific point sensors or deliberately introduced reflection or interference sites, that is an intrinsic fibre optic sensor.

Various types of distributed fibre optic sensor are known and have been proposed for use in various applications.

U.S. Pat. No. 5,194,847 describes a distributed acoustic fibre optic sensor for intrusion sensing. A continuous optical fibre without any point sensors or specific reflection sites is used. Coherent light is launched into the optical fibre and any light which is Rayleigh backscattered within the optical fibre is detected and analysed. A change in the backscattered light in a time bin is indicative of an acoustic or pressure wave incident on the relevant portion of optical fibre. In this way acoustic disturbances at any portion of the fibre can be detected.

GB patent application publication No. 2,442,745 describes a distributed acoustic fibre optic sensor system wherein acoustic vibrations are sensed by launching a plurality of groups of pulse modulated electromagnetic waves into a standard optical fibre. The frequency of one pulse within a group differs from the frequency of another pulse in the group. The Rayleigh backscattering of light from intrinsic reflection sites within the fibre is sampled and demodulated at the frequency difference between the pulses in a group.

Distributed fibre optic acoustic sensing therefore provides useful and convenient sensing solutions that can monitor long lengths of optical fibre with good spatial resolution. For instance a distributed fibre optic acoustic sensor, such as may be used for monitoring a pipeline, can be implemented with sensing portions 10 m long in up 40 km or more of optical fibre.

Each sensing portion can detect any incident acoustic disturbances and such sensor have been proposed for use in intrusion detection systems, condition monitoring systems and operational monitoring, i.e. monitoring the operation of some apparatus.

The present invention relates to improved methods and apparatus for fibre optic distributed acoustic sensing.

Thus according to the present invention there is provided a method of distributed acoustic sensing comprising: using a fibre optic distributed acoustic sensor to detect acoustic signals wherein the fibre optic distributed acoustic sensor comprises at least one optical fibre deployed in an area of interest such that at least one section of said optical fibre is deployed to monitor the acoustic response of a cavity to incident acoustic signals.

The method of the present invention therefore uses a fibre optic distributed acoustic sensor to detect acoustic signals. However the method of the present invention uses a fibre optic distributed acoustic sensor wherein at least one section of the fibre optic is deployed so as to monitor the acoustic response of a cavity The optical fibre may be deployed so that a section of the optical fibre runs through or adjacent a cavity. By deploying at least one section of the optic fibre within or near a cavity, that section of the distributed acoustic sensor can be optimised to effectively detect particular frequencies that correspond to the resonant frequency of the cavity. The cavity may therefore be dimensioned such that it resonates at a particular desired frequency, which can be detected by the distributed acoustic sensor.

As mentioned above fibre optic distributed acoustic sensing (DAS) is a known technique whereby a single length of optical fibre is interrogated, usually by one or more input pulses of light, to provide substantially continuous sensing of acoustic activity along its length. Optical pulses are launched into the fibre and the radiation backscattered from within the fibre is detected and analysed. By analysing the radiation backscattered within the fibre the effect of acoustic signals incident on the fibre can be detected. The backscatter returns are typically analysed in a number of time bins, typically linked to the duration of the interrogation fibres and hence the returns from a plurality of discrete sensing portions can be separately analysed. Thus the fibre can effectively be divided into a plurality of discrete sensing portions of fibre. Within each discrete sensing portion disturbance of the fibre, for instance from acoustic sources, cause a variation in the amount of radiation which is backscattered from that portion. This variation can be detected and analysed and used to give a measure of the intensity of disturbance of the fibre at that sensing portion. Whilst such sensors have principally been used to detect acoustic waves it has been found that the fibres are sensitive to any type of mechanical vibration and thus provide an indication of any type of mechanical disturbance along the fibre. It has further been found that a fibre optic distributed acoustic sensor can be used to detect seismic waves including P and S waves.

As mentioned the optical fibre may be deployed such that a section of the optical fibre runs through the cavity. The section of fibre that lies within the cavity may be arranged so that one or more discrete sensing portions of the fibre lie within the cavity although in some instances only part of a sensing portion of fibre may be arranged within a cavity. By arranging a particular sensing portion within a cavity, the sensitivity of that particular sensing portion to a particular frequency can in effect be amplified by dimensioning the cavity in which the sensing portion is located to be a resonant cavity at the particular frequency. In other words the cavity is arranged so as to be resonant at a particular frequency of interest. Any incident acoustic signals at the frequency of interest may therefore lead to resonance within the atmosphere of the cavity—this will typically lead to a greater acoustic disturbance on the relevant sensing portion(s) of fibre than otherwise would be the case in the absence of the cavity. Hence the sensitivity of the section of the fibre within the cavity to the frequency of interest is effectively increased due to the presence of the cavity. As mentioned the fibre may be arranged so that whole of one or more sensing portions of fibre lie within a particular cavity. It will be appreciated that the length of the sensing portions of fibre is determined by the interrogating radiation. If a particular sensing portion of fibre is actually longer than the relevant cavity then only part of the sensing portion may lie within the cavity. The increased disturbance at the resonant frequency on the section of fibre within the cavity will still lead to a preferential response at that frequency. Alternatively the fibre may be looped or coiled within the cavity to ensure that in use at least one full sensing portion of fibre is deployed within the cavity. For example if, in use, the sensing portions of fibre of 10 m long then the fibre could be coiled or looped so that at least 20 m of fibre are disposed within the cavity. This will ensure that at least one full sensing portion of fibre is within the cavity in use.

The cavity may be any type of cavity that leads to relatively well defined resonant frequencies. Advantageously the cavity may be formed by embedding an object in a surrounding material; which forms a hollow space when so embedded. For example the cavity may be formed by one or more sections of tube, through which the optical fibre extends being embedded in a surrounding material. For example, when the optical fibre is to be buried in the ground in an area of interest, at least part of the fibre may be passed through a tube which is also buried with the fibre. When buried the interior of the tube will provide the cavity. Many applications of DAS make use of a fibre buried in the ground and thus may benefit from the use of a hollow object being buried so as to form a cavity. In other applications an optical fibre may be deployed during formation of a structure and thus may run through the solid material of the structure. Again a tubular object could be embedded within the structure to provide the cavity.

A tube is useful as the diameter need not be very large (note the tube does not necessarily need to have a generally circular cross section). A diameter of a few centimetres to a few tens of centimetres may be sufficient, which does not represent a significant extra burden to embed with the fibre, e.g. to bury. As will be well understood the resonant frequencies of the cavity formed by the tube will depend on the length/diameter of the tube and so can be easily controlled. In some embodiments the ends of the tube may be generally open when deployed—but will effectively become closed when embedded, e.g. buried, so the resonant frequency is that of a closed tube. However in some applications when the tube is embedded some of the surrounding material may enter within the interior of the tube. For instance when burying a tube some of the material it is buried in, e.g. soil, sand etc. may enter into the tube when it is buried. This would especially be the case if the tube were embedded in a material such as concrete say before the concrete had set. A small amount of material intrusion into the cavity may affect the actual resonant frequencies of the cavity slightly but the arrangement would be sufficient to preferentially respond to frequencies around the desired frequency of interest. In some embodiments however the tube may be capped at one or both ends, with the optical fibre passing through a hole in the cap or a gap between the cap and the side wall of the tube with the cap in use preventing the ingress of material into the cavity formed by the tube.

The tube may be made of any convenient material such as plastics material. For ease of deployment the tube may not be a single solid tube but may, for instance, have a slit lengthwise to allow a particular part of the optical fibre to be moved into or out of the tune without needing to thread the rest of the optical fibre through the tube. The section of tube could for example to hinged lengthwise to separate. In some embodiments the tube may be assembled around the optical fibre from distinct sections of tube.

Where the optical fibre is deployed to run through (or adjacent to) a cavity in the area of interest then if the location of the cavity is known this can be used to provide calibration of the location of the optical fibre. Consider, for example a length of optical fibre of the order of 40 km in length which is buried alongside a pipeline to provide monitoring for third party interference. The fibre may be buried so as to generally follow the length of the pipeline. However over the course of 40 km the path of the pipeline and path of the fibre may vary slightly. Also, typically the optical fibre will be disposed within a fibre optic cable having protective jacket material etc. and the optical fibre may be arranged such that in a given length of cable there is a slightly greater length of optical fibre—referred to as overstuffing. This helps prevent damage to the optical fibre in the event of stretching or bending of the cable. However this means that the actual length of optical fibre within a long length of cable may not be exactly known. Also the amount of overstuff may vary over the length of the cable.

The position of the sensing portions of the DAS sensor can be determined accurately in terms of distance along the length of optical fibre, but for the reasons set out above there may be variations in the length of optical fibre running alongside a given length of pipeline. Over a length of fibre of the order of 40 km this could result in a relatively significant uncertainty in the location of a given sensing portion along the pipeline.

However if the cable runs through one or more cavities at known locations then the acoustic returns due to the presence of the cavity can be detected, for instance by looking for the sensing portion(s) which has/have a strong response at the known resonant frequency of the cavity. Such sensing portions can then be identified as those which correspond to the location of the fibre at the known location of the cavity. The use of cavities at known locations can then be used for location calibration and the method may comprise analysing the acoustic signals detected by the distributed acoustic sensor to detect the acoustic response of the cavity; so as to identify the location of the relevant section of optical fibre.

In another embodiment at least one cavity may be formed as part of the fibre optic cable in which the optical fibre is disposed. In other words the optical fibre may be part of a fibre optic cable which is manufactured to have cavities within the cable. As described above the cavities may be dimensioned to provide desired resonance frequencies. As mentioned the fibre optic cable may have at least one jacket material surrounding the optical fibre. In this embodiment the at least one jacket material is configured to define a cavity within the cable structure.

The cavity could comprise a void in at least part of the jacket material. Some fibre optic cables also comprise at least one filler material between one or more outer jacket layers and the optical fibres and additionally or alternatively the cavity could comprise a void in such filler material.

The optical fibre of the fibre optic distributed acoustic sensor may be arranged so that multiple different sections of the fibre monitor different cavities, for each a first section of fibre could run through a first cavity and a second, different section of fibre could run through a second different cavity. Cavities may be placed at regular intervals along the length of the optical fibre, or they may be selectively placed in specific regions where data about a specific frequency is desired. Two or more cavities may be arranged to have substantially the same resonant frequency as one anther and/or two or more cavities may be arranged to be resonant at different frequencies to one another.

It should be noted that whilst arranging sections of the optical fibre to pass through a cavity by increase the acoustic disturbances experienced by that section of fibre at the resonant frequency of the cavity, the acoustic disturbances at other frequencies, away from the resonant frequency of the fibre may be reduced, or at least the signal to noise ratio of the detected disturbances on the section of fibre may be reduced as compared to a section of fibre which is not deployed within a cavity. In some embodiments therefore there may be significant sections of fibre which are not arranged in a cavity to provide general distributed acoustic sensor with a few sections of fibre running through cavities to provide preferential response at one or more particular frequencies of interest. For example in the application to a DAS sensor with a buried optical fibre, only certain section of optical fibre may be buried within a cavity which large portions of the optical fibre being curried directly in the ground.

As used in this specification the term “distributed acoustic sensor” will be taken to mean a sensor comprising an optical fibre which is interrogated optically to provide a plurality of discrete acoustic sensing portions distributed longitudinally along the fibre and which can detect mechanical vibration or incident pressure waves, including seismic waves.

The method may therefore comprise launching a series of optical pulses into said fibre and detecting radiation Rayleigh backscattered by the fibre; and processing the detected Rayleigh backscattered radiation to provide a plurality of discrete longitudinal sensing portions of the fibre. Note that as used herein the term optical is not restricted to the visible spectrum and optical radiation includes infrared radiation and ultraviolet radiation. A suitable DAS system is described in GB 2442745 for example, the content of which is hereby incorporated by reference. Such a sensor may be seen as a fully distributed or intrinsic sensor as it uses the intrinsic scattering processed inherent in an optical fibre and thus distributes the sensing function throughout the whole of the optical fibre. A Rayleigh backscatter DAS system has been shown to provide very useful result but DAS sensors based on detecting Brillouin scattering or other scattering are known and the method is also applicable to such DAS sensors.

Fibre optic distributed acoustic sensing therefore provides a sensor that can monitor long lengths of optical fibre with good spatial resolution. For instance a fibre optic distributed acoustic sensor can be implemented to monitor up 40 km or more of optical fibre, for a spatial resolution, i.e. size of the individual sensing portions, of the order of 10 m or so. In other words, in use the fibre optics can effectively act as a 40 km linear array vibration sensors with individual sensors being spaced 10 m apart.

The sensor can operate using a standard, preferably single mode, fibre optic cable such as may be used for telecommunications, without the need for deliberately introduced reflection sites such a fibre Bragg grating or the like. The ability to use an unmodified length of standard optical fibre to provide sensing means that low cost readily available fibre may be used. As a single fibre of up to 40 km in length can be used as the sensing fibre in many applications only a single fibre is required to provide the extent of sensor coverage required.

As mentioned above the use of one or more cavities can therefore allow the DAS sensor to have an enhanced response to incident acoustic signals that can lead to resonance within the cavity. The method may involve applying an acoustic stimulus to an area of interest. Such an acoustic stimulus may have a frequency component which matches a resonant frequency of the cavity—or is otherwise arranged to stimulate a resonance within the cavity. The stimulus may be applied for a variety of reasons.

The method of the present invention may be particularly applicable to seismic surveys, especially surface seismic surveys. Seismic surveying is used in a variety of applications and in the oil and gas sector, seismic surveys may be conducted at numerous different stages of well constructions and operation. Seismic surveys are also used for assessing potential sites for the storage of hazardous materials such as nuclear waste for example. Carbon dioxide sequestrations schemes would also rely on seismic surveying to identify suitable reservoirs. In these applications there may again be a desire to undertake periodic seismic surveys to monitor the condition of the site over time.

Conventional seismic surveying involves deploying an array of seismometers over an area of interest and then introducing a stimulus from a seismic source into said area. Various types of seismometer are known but typically (especially in the oil and gas sensor) a geophone array is used. One particular type of seismic survey, surface reflection seismology, involves deploying a generally linear array of geophones across the surface of the area of interest and measuring the response to a seismic stimulus delivered to the surface. By determining the response times of reflections of the acoustic stimulus information about the underlying rock strata can be determined.

Various types of seismic source for producing a seismic stimulus are known, for instance explosives or air guns can be used but it is most common, especially in the oil and gas industry, to use one or more a truck mounted seismic vibrators, often referred to as a Vibraseis™ truck. The seismic vibrator is capable of injecting low frequency vibrations into the earth and can apply a stimulus with a time varying frequency sweep.

To perform a surface reflection seismology survey, the geophone array must be deployed over the surface of the area of interest. To survey a relatively wide area a large number of geophones may need to be deployed in either a linear arrangement or two dimensional deployment. Once deployed one or more seismic vibrators may be located in an appropriate position and operated to apply a desired seismic stimulus. Measurement of the response of the geophones to the stimulus are recorded and stored for analysis.

Geophone arrays suitable for seismic surveying are relatively expensive, with costs in the order of hundreds of thousands of dollars, and thus the geophone arrays are usually deployed only for the duration of the particular survey. After the survey is complete the array is recovered for use in another survey in a different location. Typically therefore the geophones are deployed in a relatively temporary manner. Whilst in some areas it may be possible to deploy the geophones by simply laying them on the ground, in many instances this may provide ineffective coupling between the geophone and the ground, especially where there may be significant vegetation. Usually therefore the geophones are mounted on stakes which are driven into the ground to couple the geophone to the earth. Deploying and subsequently recovering the array therefore can involve a significant effort, especially as the area to be surveyed may be relatively wild. This deployment also means that the geophones are exposed to the elements and strong wind or heavy precipitation may affect the readings.

If another survey is required in the future at the same location, for instance to determine whether there have been any significant changes, a geophone array must be redeployed. Ideally in order to provide readings that may easily be compared the deployment of the geophones for any subsequent survey should match the general deployment for the previous survey or surveys. However achieving exactly the same deployment of sensors may be difficult.

In the method of the present invention, as the sensing fibre and cavities are relatively inexpensive, they may be deployed in a location in a more permanent fashion as the costs of leaving the fibre and cavities in situ and using a different fibre in a different location are not significant. In the method of the present invention a fibre which is deployed in a cavity in the region of interest, for instance buried in the ground, is used as the sensing fibre. A single length of telecoms optical fibre may cost of the order of a thousand dollars or so and thus is a few hundred times cheaper than a conventional geophone array.

The method does therefore require a fibre in the area of interest and for surface seismic surveying this typically involves burying a fibre. The first time a fibre optic distributed acoustic sensor is used in the area of interest, for example when the first seismic survey is performed, it may be necessary for a fibre to be specifically buried in a desired arrangement which will involve some deployment costs. However the fibre does not need to be buried deeply and only a narrow trench will be required to lay a single fibre optic cable. The cavities can be implemented by laying the fibre through relatively narrow tubes for example and thus also do not require significant deployment effort . . . . Burying the fibre increases the coupling between the fibre and the ground and also helps to isolate the fibre from the surface weather conditions. Within a cavity, the fibre is coupled to the ground via the coupling of the cavity with the ground. A depth of ten centimetres or more may be sufficient for this purpose but to ensure good coupling and to avoid accidental exposure of the fibre, especially if deployed for a long period of time, a depth of the order of 0.5-1 m or so is preferred. It is not usually necessary to bury the fibre much deeper but it could be buried deeper if required. Typically seismic signals of interest are reflected from much lower depths and so the exact depth at which the fibre is buried is not important. The method may therefore comprise the initial step of burying a suitable fibre optic cable in a desired pattern in the ground in the area of interest.

As mentioned, as the fibre is buried in the ground it is well coupled to the ground and thus offers good performance in detecting seismic waves propagating through the ground. Also as the fibre is buried it is isolated from surface weather effects, wind and/or precipitation do not affect the operation of the distributed acoustic sensor using a buried fibre, unlike a surface mounted geophone array.

As mentioned the fibre itself can be left in-situ as the cost of another fibre for use in a different location is relatively trivial. This has the additional benefit that if another survey is required in same location in due course the same fibre can be re-used. As the fibre is buried it is relatively protected from the environment and most typical optical fibres are well suited to being buried for long periods of time. Thus the same fibre can be used for the next survey and the costs of deploying a sensor array for the subsequent survey are avoided. Thus for a location where it is likely that many periodic seismic surveys may be required over time even if the initial costs involved in deploying a buried fibre are greater than those that would be incurred in deploying a geophone array the fact that the deployment costs for the fibre optic distributed acoustic sensor are only incurred once may mean that overall deployment costs over time are lower when using a DAS sensor.

In addition as the fibre optic is buried and left in situ the fibre and the cavities will be located in the same place each time that a survey is performed. Thus the results of two surveys which are conducted using the same fibre but conducted at different times can be directly compared to determine any changes occurring over time. The ability to directly correlate the results of surveys conducted at different times is an advantage of using DAS sensors with permanently buried fibres.

As will be appreciated the DAS sensor comprises an interrogation unit which, in use, couples to one end of the fibre under test and transmits optical pulses into the fibre and detects the backscatter from within the fibre. During the seismic survey the interrogation unit will be coupled to the fibre under test. After the survey is completed the interrogation unit may be detached from the fibre and relocated for use with another different buried fibre. Thus only the fibre which is buried may remain in-situ and the interrogation unit itself may be relocated as required. The method may therefore comprise connecting at least one DAS interrogation unit to the end of at least one buried fibre in order to conduct a survey, performing the survey—which may involve stimulating the ground with one or more seismic sources and detecting the seismic signals incident on the fibre—and then removing the interrogation unit at the end of the survey but leaving the fibre in pace. The end of the fibre would be capped for protection and left safe until the next survey. In this way once the sensing fibres are in place in several locations that require periodic surveys the vibration sources and DAS interrogation units may be moved from location to location to perform the surveys without the need to deploy and recover sensor arrays.

In some applications however it may be desired to leave the whole working DAS sensor in-situ, even if a seismic source is only available for performing reflection seismology surveys periodically. A DAS interrogation unit may itself be relatively inexpensive and in some applications it may be wished to provide continual monitoring or at east monitoring on a relatively frequent basis. Such monitoring could analyse the acoustic/seismic signals received in the absence of specific stimuli, i.e. the general ambient acoustic/seismic signals. Such monitoring may help identify any changes in the general background over time and/or identify any significant acoustic/seismic events that may mean a detailed survey is required.

When the sensing fibre and cavities are initially buried, they may be located in any desired pattern as required. Whatever the actual geometry of the fibre however it is possible to vary the length of the individual sensing portions of the fibre by varying the properties of the DAS interrogator. Thus provides the ability to vary the spatial resolution in use, whilst performing a survey. This is not possible with a conventional geophone array where the deployment of the geophones is physically fixed.

During the survey the ground may be stimulated by an acoustic source such as a Vibroseis™ truck. These seismic sources produce a high energy stimulus in order that seismic waves of sufficient intensity are generated. As the DAS sensor receives the initial stimulus and reflections from various layers of rock it is beneficial that the DAS sensor has a large dynamic range.

In order to provide a large dynamic range the rate of sampling of the sensor may be relatively high so as to reduce the amount of signal change between any two successive samples to aid in reconstruction of the incident signal. This can help reduce effective clipping of the sensor. However a high data rate will produce a large number of samples so once the data has been processed to determine the overall incident signal characteristics the amount of data samples may be reduced to a desired amount, e.g. decimated, to reduce further processing and storage requirements.

When using a seismic vibrator it is typical that the vibration has a time varying frequency. The method may therefore involve correlating the signals detected with the time varying frequency to help determine the seismic signals from background noise.

The invention also relates to a fibre optic distributed acoustic sensor comprising an optical fibre deployed in an area of interest; wherein at least one section of the optical fibre is deployed so as to monitor the acoustic response of a cavity . . . .

The optical fibre may run through the cavity and the cavity may be dimensioned to resonate at a desired resonance frequency. The one or more cavities may be formed by arranging the optical fibre to run through at least one hollow object which is embedded in the area of interest, for instance buried in the ground. The hollow object may conveniently comprise a tube. Additionally or alternatively the optical fibre may be disposed within a fibre optic cable which comprises at least one cavity in the structure of the cable. All of the embodiments described above in relation to the method of the invention apply equally to the sensor according to this aspect of the invention.

The invention also relates to a fibre optic cable for use in DAS wherein the cable is structured to comprise at least one cavity. Thus according to a further aspect of the invention there is provided a fibre optic cable comprising at least one jacket material surrounding at least one optical fibre, wherein the jacket material defines at least one void in the cable. As mentioned above the cavity may be dimensioned to resonate at a desired resonant frequency. The cable may be constructed as discussed above.

It can therefore be seen that be deploying an optical fibre which is to be used as a sensing fibre in a DAS sensor within, or adjacent, a cavity in the area of interest the response at particular frequencies can be enhanced. Thus in another aspect of the invention there is provided a method of deploying an optical fibre for use in a distributed acoustic sensor comprising deploying an optical fibre in an area of interest such that at least part of the optical fibre is deployed to, in use, monitor the acoustic response of a cavity. The optical fibre may be arranged to pass through the cavity, which may be formed be a hollow object embedded within the area of interest, for example buried in the ground. The hollow object is buried so as to create a cavity which the fibre runs through.

It should be noted that the discussion above has focussed on optical fibres buried in the ground but it will be appreciated that the same principles may be applied for optical fibres which are embedded in the material of a structure to provide distributed acoustic sensing within the structure. The fibre may be embedded to rune through cavities in the material which are designed to be resonant at a particular frequency of interest so that sections of the fibre show preferential response at the frequency of interest.

The invention extends to methods, apparatus and/or use substantially as herein described with reference to the accompanying drawings.

Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

The invention will now be described by way of example only with reference to the following drawings, of which:

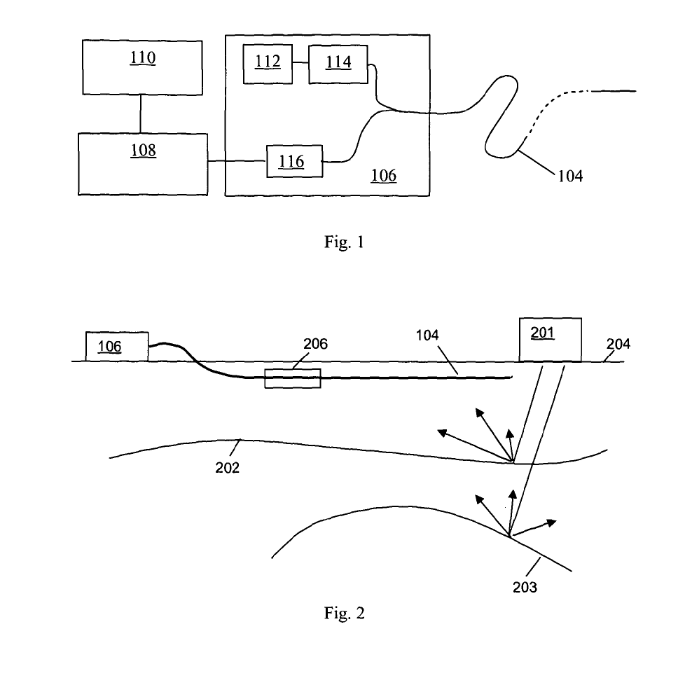

FIG. 1 illustrates the basic components of a distributed fibre optic sensor;

FIG. 2 illustrates a first arrangement of a DAS sensor arranged to provide surface reflection seismology;

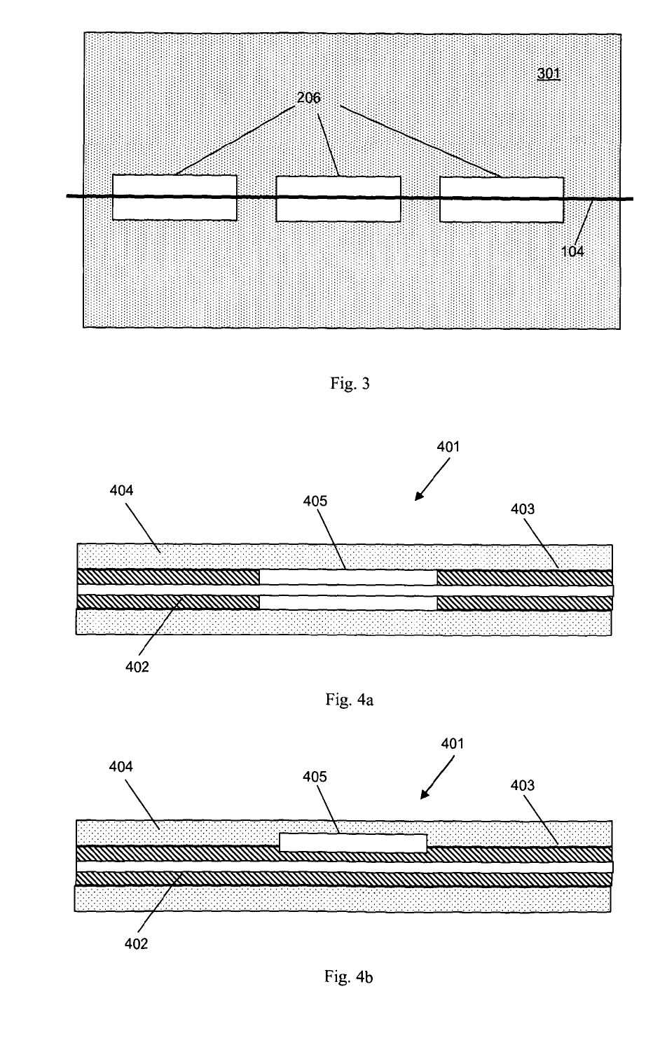

FIG. 3 shows a section of an optic fibre of a DAS sensor, in which sections are located within cavities; and

FIGS. 4a and 4b illustrate embodiments of fibre optic cable according to the present invention.

FIG. 1 shows a schematic of a distributed fibre optic sensing arrangement. A length of sensing fibre 104 is removably connected at one end to an interrogator 106. The output from interrogator 106 is passed to a signal processor 108, which may be co-located with the interrogator or may be remote therefrom, and optionally a user interface/graphical display 110, which in practice may be realised by an appropriately specified PC. The user interface may be co-located with the signal processor or may be remote therefrom.

The sensing fibre 104 can be many kilometres in length, for example up to 50 km long, although the length of the fibre may in practice depend on the size of the area of interest and the spatial resolution and deployment required. The sensing fibre may be a standard, unmodified single mode optic fibre such as is routinely used in telecommunications applications. However in some embodiments the fibre may comprise a fibre which has been fabricated to be especially sensitive to incident vibrations.

In operation the interrogator 106 launches interrogating electromagnetic radiation, which may for example comprise a series of optical pulses having a selected frequency pattern, into the sensing fibre. The optical pulses may have a frequency pattern as described in GB patent publication GB 2,442,745 the contents of which are hereby incorporated by reference thereto. As described in GB 2,442,745 the phenomenon of Rayleigh backscattering results in some fraction of the light input into the fibre being reflected back to the interrogator, where it is detected to provide an output signal which is representative of acoustic disturbances in the vicinity of the fibre. The interrogator therefore conveniently comprises at least one laser 112 and at least one optical modulator 114 for producing a plurality of optical pulse separated by a known optical frequency difference. The interrogator also comprises at least one photodetector 116 arranged to detect radiation which is backscattered from the intrinsic scattering sites within the fibre 104.

The signal from the photodetector is processed by signal processor 108. The signal processor conveniently demodulates the returned signal based on the frequency difference between the optical pulses such as described in GB 2,442,745. The signal processor may also apply a phase unwrap algorithm as described in GB 2,442,745.

The form of the optical input and the method of detection allow a single continuous fibre to be spatially resolved into discrete longitudinal sensing portions. That is, the acoustic signal sensed at one sensing portion can be provided substantially independently of the sensed signal at an adjacent portion. The spatial resolution of the sensing portions of optical fibre may, for example, be approximately 10 m, which for a 40 km length of fibre results in the output of the interrogator taking the form of 4000 independent data channels.

In this way, the single sensing fibre can provide sensed data which is analogous to a multiplexed array of adjacent independent sensors, arranged in a path.

FIG. 2 illustrates a DAS sensor arranged to perform surface reflection seismology. It will of course be appreciated however that the principles of the embodiment of the present invention may be applied to other applications such as perimeter surveillance or the like where it may be wished to preferentially detect signals at particular frequencies of interest.

The fibre 104 is, in this example, buried in the ground 204 within an area to be surveyed. A portion of the fibre 104 is located within a cavity 206. The cavity 206 may be formed by a section of tube through which the fibre 104 passes. The tube may be made of plastics material or any other suitable material. The cavity is dimensioned such that it resonates at a particular resonant frequency. By providing the resonant cavity, the section of fibre 104 located within the cavity 206 can be effectively tuned to be more sensitive to a particular frequency, the resonant frequency of the cavity 206. The resonant frequency of the cavity can be tuned to a particular resonant frequency by varying the length of the tube or the diameter of the tube, for example. Although only one cavity 206 is shown in FIG. 2, it should be understood that any number of cavities along the length of fibre 104 can be provided.

At least one end of the optical fibre is free and unburied and may be connected to interrogator 106. Interrogator 106 may be permanently connected to the fibre 104 to provide continual acoustic/seismic monitoring but in some embodiments the interrogator is removably connected to the fibre 104 when needed to perform a survey but then can be disconnected and removed when the survey is complete. The fibre 104 and cavity 206 though are buried and remain in situ after the survey ready for any subsequent survey. The fibre and cavity are relatively cheap and thus the cost of leaving the fibre in place is not great. Leaving the fibre in place does however remove the need for any sensor deployment costs in subsequent surveys and also ensures that in any subsequent survey the sensor is located in exactly the same place as for the previous survey. This readily allows for the acquisition and analysis of seismic data at different times to provide a time varying seismic analysis.

To perform a survey one or more seismic sources 201, for example Vibroseis™ trucks are located and used to excite the ground. This generates seismic waves which propagate through the ground and underlying rock. Different rock strata 202 and/or reservoirs 203 can reflect at least some of the incident seismic waves which then propagate back towards the surface. These seismic waves cause vibration of the optical fibre 104 which is detected and analysed as described above. If the seismic waves are at the resonant frequency of the cavity, the cavity will resonant and will act to amplify the vibration of the optical fibre 104.

Typically the seismic source 201 may apply a stimulus with a time varying frequency pattern and when analysing the data from the DAS sensor a frequency correlation may be applied to isolate the seismic signals of interest from background noise etc.

The stimulus applied by the seismic source 201 may be very energetic and thus any reflection from nearby reflection sites will also be relatively energetic. However the reflections from deeper sites may be significantly attenuated and may be relatively faint. Thus the DAS sensor ideally has a large dynamic range. To help cope with a wide dynamic range the sampling speed of the photodetector 116 and initial signal processing is at a high rate so as to reduce the amount of variation between any two samples. The can aids in subsequent reconstruction of the form of the incident signal. However once the general form of the signal is known a high data rate may not be required and thus the signal processor 108 may decimate the processed data to reduce further processing and storage requirements.

The result will be a series of signals indicating the seismic signals detected over time in each longitudinal section of the fibre. For the time of arrival of the seismic signals at the various sensing portions of the fibre the structural of the underlying rock can be determined using known seismic processing techniques.

The sensing fibre thus effectively acts as a series of point seismometers but at a fraction of the cost of a conventional geophone array. Further, as the fibre optic and cavity are buried, they are isolated from any surface weather conditions that can affect convention surface mounted geophones.

The fibre is typically buried to depth of about 0.5 to 1 m and thus is very much locate in the upper ground surface.

Various arrangements of the fibre 104 are possible. FIG. 2 shows a basic arrangement where the fibre 104 is buried in a generally straight line. Such an arrangement will allow effectively a two dimensional slice of the underlying ground formation to be analysed. Other arrangements are possible however.

The cavity 206 may also be located in a known location in the ground in the location of interest and knowledge of the location of the cavity may be used to help determine the relative locations of the sensing portions of the DAS sensor in the area to be monitored.

The optical fibre 104 will generally be disposed as part of a fibre optic cable and the cable will be deployed in the area of interest. Whilst the general path of the cable may be known in reality the cable may not be aligned exactly as originally intended. For instance when burying the cable the personnel deploying the cable may have diverted the cable slightly from the planned path. For instance the digging process may not have followed an exactly straight line and there may be instances where the path was deviated, for instance to avoid a large rock along the intended path.

Over a short distance this path variations may not be significant but over the length of a sensing fibre of the order of 40 km this could lead to an uncertainty over how much cable is deployed over a given distance.

Also typically for a given length of cable there may be a slightly greater length of optical fibre. However the amount of overstuff may vary over the length of the cable, and depending on the way that the cable is deployed. Thus in use whilst the distance within the optical fibre of a given sensing portion may be known, by virtue of the sampling time of the sensor, there may be some uncertainty in the position of that sensing portion in the area of interest.

However given the location of the cavity 206 is known the acoustic signals detected by the DAS sensor in use may be analysed to detect a sensing portion with a strong response at the resonant frequency of the cavity. This could be in response to ambient acoustic signals but in some instances the area of interest may be stimulated with a source which is arranged to excite the resonant frequency of the cavity 206. Thus source 201 may be operated with a frequency component at the resonant frequency of the cavity. This will excite resonance within the cavity providing a strong response in the sensing portions located at least partly within the cavity. The relevant sensing portions can then be identified and the location of those sensing portions will be known. Thus the use of one or more cavities can be used to provide knowledge of the location of defined parts of the sensing fibre and the location of other sensing portions can be interpolated based on the known positions.

It will also be appreciated that hollow structures forming cavities could be embedded in other materials in which the optical fibre is deployed. For instance in some instances an optical fibre may be embedded within concrete during formation of a structure. A hollow structure may be located in the structure (provided it is not located in a way which significantly affects the resulting structural integrity) with the fibre running through the hollow structure.

FIG. 3 shows a section of fibre 104 passing through a plurality of cavities 206 in a material 301, which may for instance be the material of a structure. Though FIG. 3 shows three cavities of the same size, it should be appreciated that any number of cavities may be provided. Although each cavity may be dimensioned such that it resonates at the same frequency, it should be apparent that individual cavities may be sized to resonate at different frequencies. The cavities may be placed at regular intervals along the optical fibre 104 or they may only be located at particular points of interest.

The above describes the cavities 206 as tubes through which section(s) of the optic fibre pass though. It should be appreciated that the invention is not limited to tubes with a circular cross-section and indeed any shape which provides a cavity through which an optic fibre can pass could be used. The cavities may be made of plastics material, but they could also be made of corrosion resistant metal or any other suitable material.

In another embodiment the cavities may be formed within the material of the fibre optic cable itself. As will be appreciated an optical fibre is typically disposed within a fibre optic cable that may comprises a plurality of optical fibres and one or more outer jacket layers. There may also be a buffer or filler material and one or more strengthening or protective elements depending on the type of cable and intended environment of use. The fibre optic structure may be arranged with one or more cavities within the structure of the fibre optic cable itself.

FIG. 4a shows one embodiment of a fibre optic cable 401 according to the present invention. The cable comprises an optical fibre 402 which will comprise suitable core and cladding material as will be understood by one skilled in the art and which may be surrounded in one or more inner jacket or protective layers. Only one optic fibre is illustrated in FIG. 4a but it will be appreciated there could be several such optical fibres.

The optical fibre 402 is surrounded by intermediate material 403. The intermediate material may comprise one or more additional jacket layers and/or may be a buffer material such as a gel or matrix designed to protect the optical fibre. The cable also comprises one or more outer jacket layers 404, e.g. tom provide environmental protection and/or the required cable stiffness. The intermediate material 403 and outer jacket layer(s) define a void 405 which therefore acts a cavity through which the optic fibre 402 runs. The void may be provided simply be the absence of certain materials of the fibre optic cable structure, such as intermediate material 403, with the remaining materials providing the necessary structural integrity to the cable to maintain the cavity. In some embodiments however there may be additional structural items (not shown) to maintain the cavity such as membranes to hold back a gel buffer fluid, or a sheath to provide rigidity to the cavity.

FIG. 4b shows another embodiment of the fibre optic cable having a void therein wherein the outer jacket material 404 and intermediate material 403 co-operate to form a void adjacent the optical fibre 402.

1. A method of distributed acoustic sensing comprising: using a fibre optic distributed acoustic sensor to detect acoustic signals wherein the fibre optic distributed acoustic sensor comprises at least one optical fibre deployed in an area of interest such that at least one section of said optical fibre is deployed to monitor the acoustic response of a cavity to incident acoustic signals wherein the cavity is dimensioned such that the cavity resonates at a desired frequency.

2. (canceled)

3. A method as claimed in claim 1 wherein at least one section of said optical fibre is deployed to run through said cavity.

4-5. (canceled)

6. A method as claimed in claim 1 wherein the cavity comprises the internal space of a hollow object embedded within the area of interest.

7-8. (canceled)

9. A method as claimed in claim 6 wherein at least part of the optical fibre is buried in the ground and the hollow object is also buried in the ground.

10. A method as claimed in claim 9, wherein said optical fibre is permanently buried in the cavity in the ground.

11. (canceled)

12. A method as claimed in claim 1 wherein the location of the cavity in the area of interest is known and the method comprises analysing the acoustic signals detected by the distributed acoustic sensor to detect the acoustic response of the cavity; so as to identify the location of the relevant section of optical fibre.

13. A method as claimed in claim 1 wherein said cavity is formed as part of a fibre optic cable comprising the optical fibre.

14. A method as claimed in claim 13 wherein the fibre optic cable comprises at least one jacket material surrounding the optical fibre and said at least one jacket material defines a cavity within the cable.

15. A method as claimed in claim 1 wherein each one of a plurality of different sections of fibre is deployed to monitor one of a plurality of different cavities.

16. A method as claimed in claim 15 wherein at least two of said plurality of cavities have the same resonant frequency.

17. A method as claimed in claim 15 wherein at least two of said plurality of cavities have a different resonant frequency to one another.

18. A method as claimed in claim 1 comprising launching a series of optical pulses into said optical fibre and detecting radiation Rayleigh backscattered by the fibre; and processing the detected Rayleigh backscattered radiation to provide a plurality of discrete longitudinal sensing portions of the fibre.

19. A method as claimed in claim 1 comprising applying an acoustic stimulus to the area of interest.

20. A method as claimed in claim 19 wherein said acoustic stimulus comprises a frequency component which matches a resonant frequency the cavity.

21. A method as claimed in claim 19 wherein applying an acoustic stimulus to the area of interest comprise stimulating the ground using a seismic source.

22. A method as claimed in claim 21 wherein the seismic source provides a stimulus with a time varying frequency and wherein the method comprises correlating the output of the distributed acoustic sensor with the time varying frequency.

23. A method as claimed in claim 1 comprising using said fibre optic distributed acoustic sensor to detect seismic signals as part of a seismic survey.

24. A method as claimed in claim 1 comprising the step of connecting an interrogator unit to the end of said optical fibre to provide said distributed acoustic sensor and, after using said sensor, disconnecting said interrogator unit.

25. A method as claimed in claim 1 comprising the step of varying in use, the length of the sensing portions of the distributed acoustic sensor.

26. A method of deploying an optical fibre to be used for distributed acoustic sensing comprising deploying at least part of the fibre so as to, in use, monitor the acoustic response of a cavity wherein the cavity is dimensioned such that the cavity resonates at a desired frequency.

27-28. (canceled)

29. A fibre optic distributed acoustic sensor comprising an optical fibre deployed in an area of interest; wherein at least one section of the optical fibre is deployed so as to monitor the acoustic response of a cavity wherein the cavity is dimensioned such that the cavity resonates at a desired frequency.

30. (canceled)

31. A sensor as claimed in claim 29 wherein the optical fibre is arranged such that, in use, one or more discrete sensing portions of the fibre optic distributed acoustic sensor lie within the cavity.

32. A sensor as claimed in claim 31 wherein at least one section of fibre within a cavity is looped or coiled within the cavity.

33. A sensor as claimed in claim 29 wherein the cavity comprises the internal space of a hollow object embedded in the area of interest.

34. (canceled)

35. A sensor as claimed in claim 33 wherein the hollow object has closed ends with a hole for the optical fibre.

36. A sensor as claimed in claim 29 wherein the optical fibre is disposed within a fibre optic cable and the cable comprises at least one cavity.

37. A sensor as claimed in claim 29 wherein each one of a plurality of different sections of fibre is deployed to monitor one of a plurality of different cavities.

38. A sensor as claimed in claim 37 wherein at least two of said plurality of cavities have the same resonant frequency.

39. A sensor as claimed in claim 37 wherein at least two of said plurality of cavities have a different resonant frequency to one another.

40. A fibre optic cable comprising at least one jacket material surrounding at least one optical fibre, wherein the jacket material defines at least one void in the cable wherein the void is dimensioned so that a cavity created by the void resonates at a desired frequency.
